(19) United States
(12) Patent Application Publication
(10) Pub. No.: US 2022/0188279 A1
(43) Pub. Date: Jun. 16, 2022

(54) SYSTEMS AND METHODS FOR CREATING AND TRACKING IMPLEMENTATION OF A CONSOLIDATION OF DATA DURING A MIGRATION FROM ONE OR MORE SOURCE SYSTEMS TO ONE TARGET SYSTEM

(71) Applicant: CHS Inc., Inver Grove Heights, MN (US)

(72) Inventors: Umadevi Krishnaraju, Apple Valley, MN (US); Melissa Adams, Stacy, MN (US); Levi Paulson, Cottage Grove, MN (US)

(21) Appl. No.: 17/119,236

(22) Filed: Dec. 11, 2020

(51) Int. Cl. G06F 16/21; G06F 16/25

(52) U.S. Cl. CPC G06F 16/214; G06F 16/258

(57) ABSTRACT

Systems and methods for creating and tracking implementation of a consolidation of data during a migration from one or more source systems to one target system are described herein. One system includes a computing device, having a processor and memory, and instructions stored in memory that are executable by the processor wherein a set of software objects and their attributes are identified based on metadata of the target system, a first subset of the software objects is selected to identify information needing to be migrated from a first source system of the one or more source systems to the target system, and a second subset of the software objects is selected to identify information needing to be migrated from a first source system of the one or more source systems to the target system, and wherein the first and second subsets are merged together to form a merged subset.

### TECHNICAL FIELD

The present disclosure relates to creating and tracking implementation of a consolidation of data during a migration from one or more source systems to one target system.

### BACKGROUND

Data migration from one application to another happens a lot in the current field of information systems. For example, when an application user upgrades from a legacy application to a new version of the application, data typically needs to be migrated either to within the data storage structure used by the new version, or some data items need to be converted for use by the new version as it will not be able to use the data items in their current form. Another example is when a user switches from an application created by one provider to an application created by another provider as, typically, the data arrangements and formats of the data are different and incompatible.

In many such instances, the organization of the data (data structure) may be different between the two systems making the migration of the data difficult to accomplish. For example, the data from the legacy system may be unreadable by the new system and, therefore, simply providing access to the data by the new system may not make the new system functional.

In other situations, the format of the data may be different which could provide in an incorrect result when the data is used by the new system. A simple example of this is with regard to a date field wherein in one legacy system the date is formatted as MM/DD/YY, and a second legacy system the dates are MM/DD/YYYY, and in the destination system the format is DD/MM/YYYY. Using dates formatted from the legacy systems in the destination system will either return a nonsensical result (e.g., not enough numbers, or a number larger than any possible month) or an incorrect result (04/01/2020, interpreted by the destination system as Jan. 4, 2020 rather than Apr. 1, 2020 as provided in the second legacy system).

When working in a large enterprise entity where there may be many systems, for example, different systems in different business units or used by subsidiaries, it may be particularly difficult to migrate these diverse systems into a new system whether migrated individually or at the same time. In particular, the logistics of tracking what items of data have been migrated, what items need conversion, what items have not yet been migrated, and what items are not capable of migration in their current form, can be very difficult.

Further, previous organization systems did not allow for standardizations of rules across an enterprise system with respect to a certain type of data, making consistency across the system difficult to track and maintain as the rules created were specific to data within one area of the system. This also made the enactment of enterprise-wide data practices difficult and very cumbersome to accomplish.

Additionally, entries were collected with respect to a large entity and could not be reorganized across entities of the enterprise system, for example, by grouping attributes of objects across entities. These traditional programs also did not include any field ownership information or tracking which could be beneficial for auditing and tracking changes to the data.

### BRIEF DESCRIPTION OF THE DRAWINGS

FIG. 1 illustrates an access portal display showing a data migration management structure in accordance with one or more embodiments of the present disclosure.

FIG. 2 illustrates an access portal display showing a data migration management rules organization structure in accordance with one or more embodiments of the present disclosure.

FIG. 3 illustrates an access portal display showing a data migration management rules detail structure in accordance with one or more embodiments of the present disclosure.

FIG. 4 illustrates a computing device being utilized for data migration management in accordance with one or more embodiments of the present disclosure.

FIG. 5 illustrates another computing device being utilized for data migration management in accordance with one or more embodiments of the present disclosure.

FIG. 6 illustrates a method for data migration management in accordance with one or more embodiments of the present disclosure.

### DETAILED DESCRIPTION

The present disclosure provides systems and methods for creating and tracking implementation of a consolidation of data during a migration from one or more source systems to one target system that overcome the above issues. For example, one system includes a computing device, having a processor and memory, and instructions stored in memory that are executable by the processor wherein a set of software objects and their attributes are identified based on metadata of the target system, a first subset of the software objects is selected to identify information needing to be migrated from a first source system of the one or more source systems to the target system, and a second subset of the software objects is selected to identify information needing to be migrated from a first source system of the one or more source systems to the target system, and wherein the first and second subsets are merged together to form a merged subset.

Siloed data is a big issue large entities face as it does not allow for data sharing and makes migration more difficult as the data cannot be accessed by other parts of the entity, which such access may have several benefits, as discussed herein. Accordingly, it is in the interest of the entity to unsilo their data by consolidating the data in a single source and this can be effectively accomplished through use of the embodiments described herein.

Embodiment of the present disclosure can consolidate information across various enterprise sub-systems (software systems within the enterprise entity that do not share the same data) utilized by the entity into a standardized schema that can be utilized across the enterprise system. It can accomplish this by, for example, capturing metadata from sub-systems (e.g., SAP applications) to determine attributes associated with the data such as locations of data within data strings, data format (number of characters allowed, order of items provided in the data), type of field, check tables, etc. Some embodiments can take unconsolidated data from multiple enterprise systems, consolidate the rules for handling the data, and map data locations and formats so that all data can be utilized by a single system.

Such a process can be used to migrate multiple legacy systems with legacy data formats to a destination system. To accomplish this, the legacy data is extracted into a staging area, the data is then transformed, if necessary, and then loaded into new destination application system. For example, in some embodiments, data from dozens of legacy systems can be standardized and merged together simultaneously, in this way.

The migration can include information regarding where data is stored and the format attributes, such as the data's characteristics/limitations. Examples of metadata that can be migrated are that a customer name is stored in customer field 1, that an address is stored in an address line field, and that the address has a character limit of 40 characters. Metadata regarding an email message can, for example, be time the message was sent, time received, sender ID, receiver ID, other information about the message, but does not include information about the content of the message itself.

The embodiments of the present disclosure track different types of rules regarding the handling of the data during the migration process. These rules can include mapping rules, business rules, and technical rules.

Mapping rules dictate a source (e.g., legacy device) location and/or source data format and/or content and destination locations for that data. Business rules are instructions regarding how data is managed during the migration process. Business rule can utilize mapping rules as part of their rule making. Technical rules are the software programmer's interpretation of a mapping rule or business rule. These rule types will be discussed in more detail below.

With regard to business rules, one example of a business rule is: if a balance was posted in a general ledger account and there was a reversing entry, then don't carry over both entries, but rather consolidate them. As can be understood from this example, a business rule is not data stored in a field, but rather, an instruction on how to manage data stored in fields that need to be interpreted during the extraction and/or migration process. Business rules can include mapping rules.

An example of a mapping rules is, for instance, the location of certain data in the legacy system and its destination location in the new system. Or mapping rules can be more complex rules, such as transformation logic (the actual manipulation of the data), as described above, that can be implemented before the data is delivered to its destination in the destination system. For example, a mapping rule can define a software code script to modify the data to translate it from a first format to a second format, thereby making the data usable by the destination system.

Mapping can also be viewed as a source-system level rule where the treatment of certain data may change based on the source and destination systems being used. Business rules can be viewed as enterprise-wide rules, where they are applied to a certain data type regardless of source or destination.

For example, fixed asset records can be utilized in multiple systems within a large entity. For instance, they can reside in sub-systems called: a corporate finance environment sub-system, a operations environment sub-system, and a tax information environment in a third separate tax processing sub-system. In some data migration projects, data from all of these systems then must be consolidated from across the systems, translated into a standardized schema, and then loaded into the destination system.

Through use of embodiments of the present disclosure, the data from these distinct sources can be migrated effectively from their source sub-system locations to the destination system. Further, in some implementations, review can be undertaken to remove duplicate data from the destination system or that may be entered in multiple source sub-systems and duplicates created when the data sets are merged prior to migration to the destination system.

In prior approaches, an Excel-type spreadsheet was used to track translation rules for each item within each system, which quickly became overly complex and difficult to know what had been accomplished and what had not. This is because an Excel-type spreadsheet creates a two-dimensional (2D) matrix rule set, (e.g., customer name->mapping rule used for one particular system), but this process cannot produce a three dimensional (3D) result (e.g., customer name->rules for multiple systems). The present disclosure describes a system where the rules can be readily applied based on source system using a 3D rule organizational system.

To create an Excel-type system that would provide a less useful, but somewhat similar result, one would create a first tab having the rules for a first sub-system, a second tab with the rules for a second sub-system and a new tab for each subsequent sub-system, with each tab having rule entries for each piece of information to be extracted. As can be understood from this description, it can quickly become difficult to manage such a system when several sub-systems or destination systems are being migrated.

Additionally, another drawback to an Excel-type approach is that it is difficult to manage other information about the applicability of the rule. For example, it may be beneficial to know a version identifier for the rule, the modification (e.g., when the rule was updated) history of the rule (dates of modifications to the rule), who modified the rule, what changes were made, and other beneficial information. This information may, for example, be important for migration management or audit purposes among other uses. For example, in an audit context, it may be of interest for an auditor as to who said that certain dollar amounts should be moved to a particular GL account versus to a different GL account. The data may indicate, for example, that the financial controller made the request and it was communicated to a particular user that entered the change. This can be very helpful in determining how and when changes were made and by whom.

For example, embodiments of the present disclosure may also include reporting capabilities. The system can allow a user to select one or more criteria and then report all fields that are within a certain scope of the search query (e.g., customer name fields) or fields that have to do with a certain type of data (e.g., all rules having to do with GL balances or fixed assets or for materials) based on the criteria provided by the user. This allows a user to, for example, run a report showing rules that apply to a particular data set and to print that data out for review, among of the functions of such a report.

In practice, embodiments of the present disclosure can allow for a functional team (data migration rules setters) to set up business rules so that a technical team (team implementing the rules using code scripts) can see and understand that those rules apply to the data being viewed, so code to implement them can be created. The technical team then makes a notation indicating the rule has been coded to inform the functional team that the business rule has been implemented. The functional team can then do testing to make sure the technical rule created to implement the business rule performs as intended.

The embodiments of the present disclosure provide a system that maps data from one or more legacy systems to a destination system and also allows tracking of various update information, such as the version ID, update history (date rule was created, when changes were made, etc.), contents of the update, and/or who made the update, among other suitable information.

Tracking the update history can be important, for example, where an IT manager manages one of the systems and then retires or leaves the company. Typically, in the past, the institutional knowledge the former employee/contractor had is then lost as the employee/contractor takes that knowledge with them, but in the embodiments of the present disclosure, some of that knowledge can be retained in the system and accessed by the employee/contractor taking the former employee/contractor's position.

Another advantage of consolidation of the data sets is that in large enterprises, each silo of data may have had its own manager or management team. This can lead to inconsistent data management policies and more people employed to manage the systems. With the embodiments of the present disclosure, a single manager can manage all data.

Another advantage of one data source is that the data can be used by multiple areas where it could not have been in prior systems. In big enterprise systems, the enterprise may not have a holistic view of, for example, a customer's data and thereby, may make decisions that are not fully informed because important data was not accessible, as it was data from another sub-system within the enterprise system.

For example, in a financial loan environment, a customer may be present in three different sub-systems within the enterprise system and the enterprise, when looking at one sub-system may indicate that the customer is qualified for a $200,000 credit to buy fuel. In another sub-system that same customer will also be qualified for the same $200,000 credit, but to purchase fertilizer, and in a third sub-system qualify for the same $200,000 credit for grain or seed inputs. In this manner, the creditor can overextend credit because the sub-systems within the system are not sharing data.

Another example is where a customer receives a discount for a volume of purchases. If the data is not accessible between various sub-systems then the customer may receive a lower discount than the are entitled based on the total amount of purchases in all areas of the system.

A third example is where data aggregation is needed for reporting. For example, an enterprise may need to report its inventory of grain (e.g., to the Commodity Futures Trade Commission (CFTC)) enterprise-wide which may be held by different sub-systems of the enterprise. To accomplish this, currently, investigators need to access each sub-system and record the amount and then total the amounts. With embodiments of the present disclosure, the data is already available at one source and, accordingly, a user can query the system and receive a sum without accessing each area separately.

One example of setting up and performing a migration includes: creating, manually, the coding to manage the translations, generating the coding scripts, viewing a task available by the destination system (e.g., generate a W-9 tax form), determining data needed for performing the task (e.g., need legal name), reviewing available data in legacy system to find the correct data field to use (e.g., contact name, business name, sales agent name), defining a script to extract the data, translate the data, and migrate the data to the destination system, and then the business rule is recorded and code used to implement the rule also recorded (technical rule), so the code can be reviewed to see whether it meets the goal of the business rule. In some embodiments, rules can be cloned, so something needing a similar rule can be inserted into a new rule section providing the same rule functionality on a different set of data.

Examples of source or destination systems include: enterprise resource planning software JDE (Oracle) or SAP. Migration can occur, for example, where a operational sub-system is being operated on one JDE instance and another part of the enterprise is being operated on another instance of JDE. The goal of the migration is to decommission the JDE instances and migrate to a single SAP instance.

When setting up a new legacy system for migration, the migration tool can access metadata from the legacy system and define the types of data (e.g., based on the format of the metadata). In various embodiments, if any instance (a use of the same legacy system by another part of the enterprise) of a certain legacy system has already been set up in the migration tool and now another instance of that legacy system is to be migrated, the migration tool windows and drop down choices can be cloned from the previous legacy instance migration process, so that the user does not have to configure the migration tool interface regarding the migration of the new instance from scratch.

In some embodiments, the user has the option of selecting a different destination system from a list of possible destinations. The migration system configuration and details, such as screen content and drop down list content can be preconfigured for each destination. In such an implementation, the choices of objects on the drop down lists would change to those items needed for translation to the selected destination.

In some embodiments, the system may have a locking feature which locks access to a rule record such that only one user may access a rule record at any given time. The system can include scripts to update data automatically (if a rule version is updated, this information can be updated elsewhere in the system).

In the following detailed description, reference is made to the accompanying drawings that form a part hereof. The drawings show by way of illustration how one or more embodiments of the disclosure may be practiced.

The figures herein follow a numbering convention in which the first digit or digits correspond to the drawing figure number and the remaining digits identify an element or component in the drawing. As used herein, “a” or “a number of” something can refer to one or more such things. For example, “a number of documents” can refer to one or more documents.

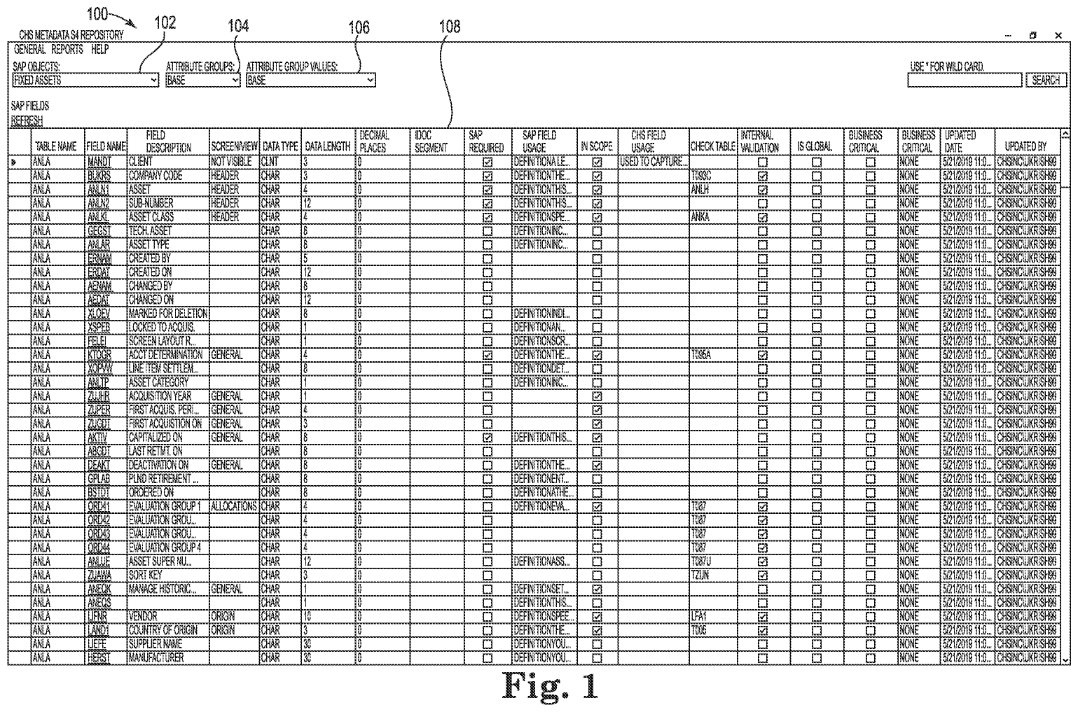

FIG. 1 illustrates an access portal display showing a data migration management structure in accordance with one or more embodiments of the present disclosure. FIG. 1 provides a view of the data migration management structure 100 from a high level. In implementation, this will be an initial screen a user may see once a destination system has been selected.

From this screen, the user can select certain objects in the data set to be viewed in the area 108. From these viewed objects, the user can select an object and then view more details about that object.

To select objects to be viewed, the user can make selections in one or more of the drop down lists 102, 104, and 106. The objects available in the object drop down list at 102 are specialized to the destination system (in the illustrated case, an SAP instance). Examples of items in this drop down list are large subsets of the enterprise, such as subsidiaries, or business units, such as lending, asset management, legal, etc. Data objects can, for example, be defined across enterprise functions to include, but are not limited to: Financial, Operational, Procurement, Sales and Distribution, Routing and Fulfillment, Manufacturing, and Maintenance related domains.

Since the destination may have many objects, the structure 100 in the embodiment of FIG. 1 includes two other drop down lists: 104, that is a smaller subset of the object drop down list, and, 106, that is a smaller subset of the drop down list 104. In such embodiments, when a selection is made in drop down list 102, the items available for selection in drop down lists 104 changes to show items that are subsets of the object selected from list 102. Likewise, when a selection is made in drop down list 104, the items available for selection in drop down list 106 changes to show items that are subsets of the object selected from list 104. In this manner, the interface is customized based on the unique selections made by the user.

The embodiment of FIG. 1 provides an example of the types of drop down lists that can be utilized. This embodiment includes, as drop down list 104, an attribute group drop down list and, as drop down list 106, an attribute group values drop down list to reduce the number of items displayed at 108. The attribute group drop down list breaks the objects into multiple sub-groups thereby limiting the number of items displayed. Examples of items in this drop down list are smaller subsets of the selected object from the object drop down list, such as in the case of asset management: corporate holdings, retail holdings, land holdings, etc.

The attribute group values drop down list further narrows the objects displayed based specific values within the data. For example, the values could be: market values, tax values, cash assets, mortgage amounts, credit extended values, and/or other such data. Further, this list does not have to be specific to values and could be another characteristic of the data that would allow for the dataset to be divided into subsets for purposes of narrowing the displayed results in area 108, such as further subsets of one of the items on the drop down list 104.

In the embodiment of FIG. 1, display area 108 has headings for a lot of sortable information regarding data records stored in the system. In the example shown, the information provided includes the table name where the data is located, the field name where the data is located, a field description, a screen view of where the data may be viewable by a user, a data type, a data length, number of data decimal places, a data segment location, whether the destination application (e.g., SAP) is required to use the data, if so the field that uses the data in the destination application, whether the data is used in the scope of the sub-system selected, legacy system field usage, check table data, whether internal validation has occurred, whether the data is used globally across multiple sub-systems, whether the data is business critical, date the data was updated, and the identification of the user that performed the update. The reader should understand that other additional or different information can be provided in various embodiments, and that the items can change based on the selections made in drop down lists 102, 104, and 106. For example, several update dates with corresponding information can be presented or accessed, which can be beneficial for audit purposes, among other uses. Further, in some embodiments, the displayed data can be sorted based on any column of information shown.

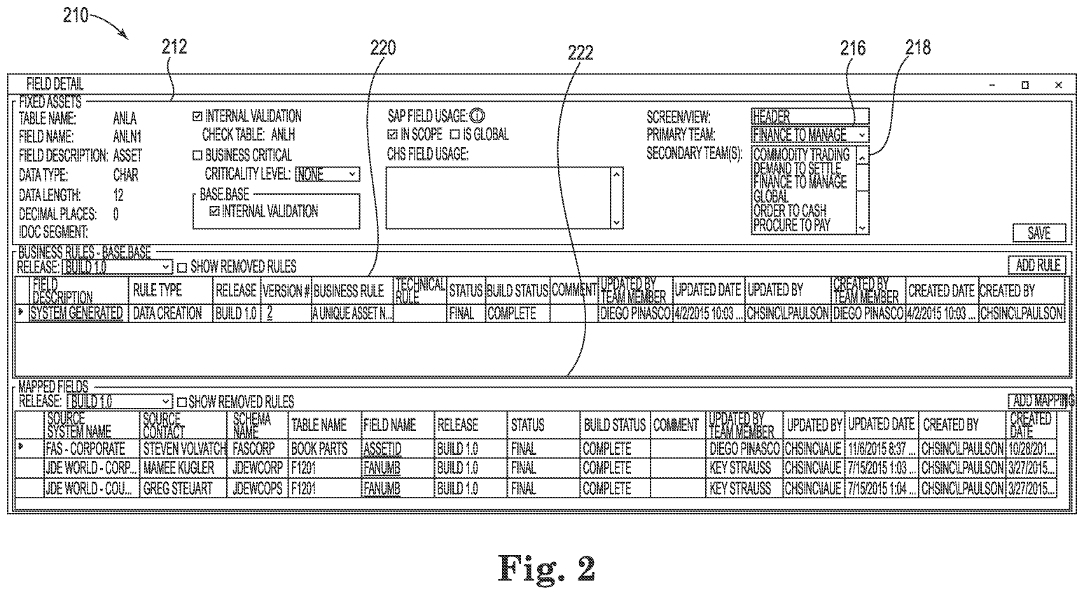

FIG. 2 illustrates an access portal display showing a data migration management rules organization structure in accordance with one or more embodiments of the present disclosure. FIG. 2 illustrates a field detail screen 210 that is viewable by a user when one of the objects displayed in area 108 of FIG. 1 is selected.

In this example, the object selected is “fixed assets” and information shown is for an item on the displayed list in area 108. The upper section of this display 212 allows for the entry of the information shown in area 108 of FIG. 1 and/or additional information about how the data is to be used (e.g., at 216, the primary team that will use the data and any other teams using the data, at 218.

As shown in FIG. 1, this information can be presented in a 2D matrix. However, the information regarding business rules in area 220 and/or mapping rules in area 222 provide the additional third dimension to this structure.

As discussed above, business rules allow the system to capture rules and standards associated with a specific value on a data object and how that data is to be handled when migrated. Mapping rules allow the system to capture data mapping details across different Enterprise Resource Planning and IT Systems, enabling data migration and consolidation wherein no translation is necessary and data can be extracted from a field in a legacy system and mapped to a location in the destination system.

In the example of FIG. 2, the area 220 shows a number of business rules associated with the selected object. Information describing each rule can, for example, include: release number, field description, rule type, version ID, description of the business rule, description of the technical rule, status of the rule making process, status of the build, comments about the rule, team member that proposed an update to the rule, date the rule was updated, the user that coded the update, team member that created the rule, date the rule was created, and the user the coded the rule when it was created, among other suitable information for example referencing external files.

The reader should understand that other additional or different information can be provided in various embodiments, and that the items can change based on the selections made in drop down lists 102, 104, and 106 of FIG. 1. Further, in some embodiments, the displayed data can be sorted based on any column of information shown.

In some embodiments, the system utilizes both business rules and technical rules. Business rules are instructions from an administrator of the system to technical personnel (e.g., software coders) on how the data should be handled during the migration process. Technical rules are coding based instructions that can be read by a technical team member to tell them the coding changes made to implement the goal of the business rule being implemented.

Having both business rules and technical rules can be beneficial, for example, when checking to make sure that a business rule is being properly implemented as the technician's understanding of the business rule is recorded in the system and can be checked, for instance, before the migration of data occurs. This can also be beneficial in finding the cause of erroneous data. This can be accomplished because the intent of the rule and the implementation of the rule can both be referenced to understand the context of what the code was supposed to accomplish and whether the resulting data is incorrect due to the coding of the business rule (created by the technical rule), among other benefits.

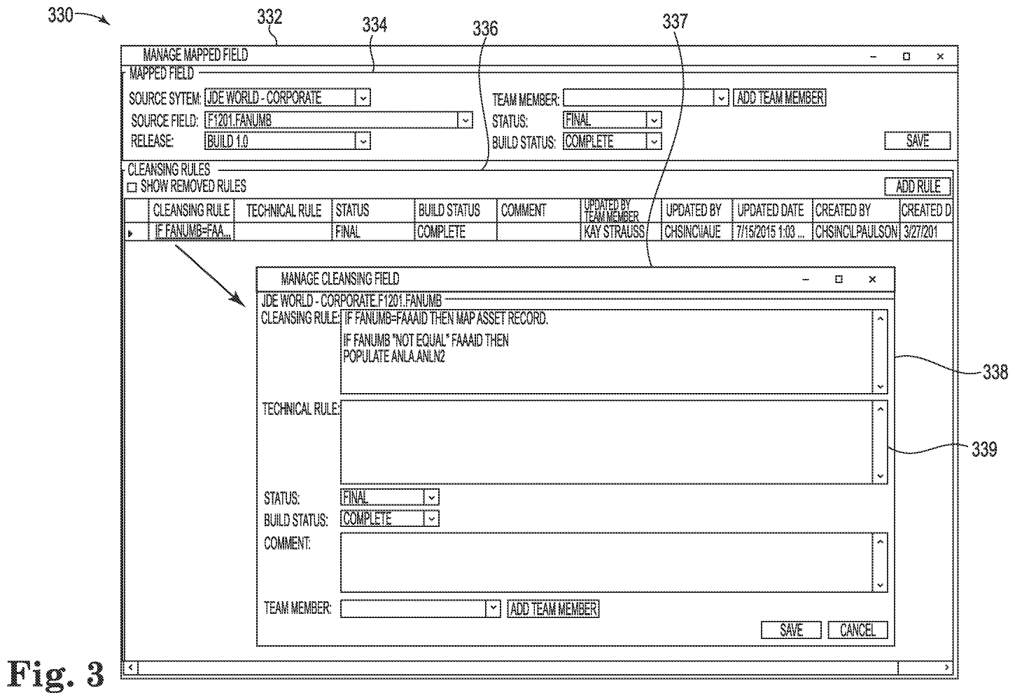

Area 222 provides information about the variety of mapping rules that are being used for the selected object. Information describing each mapping rule can, for example, include: release number, source system name, source contact name, schema name, table name, field name, status of the rule making process, status of the build, comments about the rule, team member that proposed an update to the rule, date the rule was updated, the user that coded the update, team member that created the rule, and date the rule was created. This information can be provided by metadata or via user inputs, such as through an input screen like that shown in FIG. 3.

FIG. 3 illustrates an access portal display showing a data migration management rules detail structure in accordance with one or more embodiments of the present disclosure. FIG. 3 illustrates a data entry interface 330 that allows entry of data into the migration system. Although illustrated as a mapping rules field management interface, it should be understood that a similar interface is provided for the input of business rules data when entry of a business rule data is needed.

In the embodiment illustrated in FIG. 3, when mapping data is to be entered, a window 332 can be opened to allow entry by the user. Within this window is an area 334 having a number of data entry fields and drop down lists where data can be entered or selected. For example, the source system can be selected, the field at the source where the data is being retrieved can be selected, and information such as release number, team member entering the data, status of the mapping rule being created or edited, and build status, can be entered or selected.

In the example of FIG. 3, a cleansing rule data entry area 337 is illustrated. In this area, a rule description is shown at 338 wherein the intended function of the rule is described. This rule is not yet implemented as the technical rule has not yet been entered at 339. Once the technical rule is added, this record of the rules in 338 and in 339 can be implemented by the migration system and can be used to track the progress of the migration process and be available for audit purposes, among other uses.

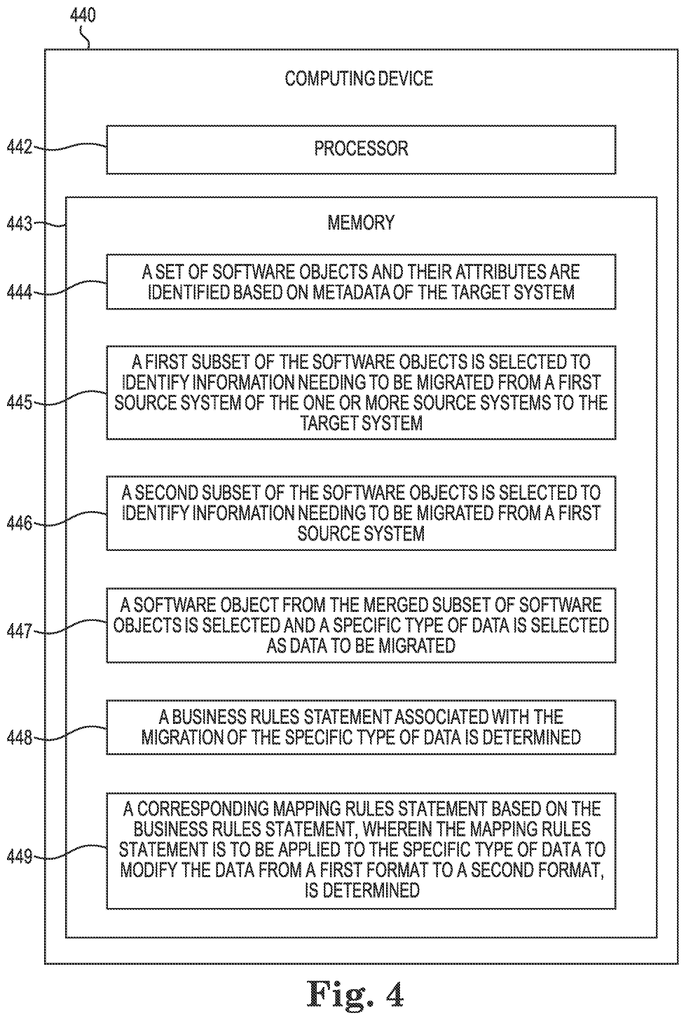

FIG. 4 illustrates a computing device being utilized for data migration management in accordance with one or more embodiments of the present disclosure. FIG. 4 represents one way in which a computing device can implement an embodiment of the present disclosure.

For example, at 440 a computing device, having a processor 442 and memory 443 is illustrated. The computing device includes instructions stored in memory that are executable by the processor. The computing device can be any computing device suitable for providing the embodiments described herein. In the illustrated example, a set of software objects and their attributes are identified based on metadata of the target system at 444.

At 445, a first subset of the software objects is selected to identify information needing to be migrated from a first source system of the one or more source systems to the target system. A second subset of the software objects is selected to identify information needing to be migrated from a first source system of the one or more source systems to the target system, at 446. These first and second subsets are merged together to form a merged subset.

Instructions are also provided wherein, at 447, a software object from the merged subset of software objects is selected and a specific type of data is selected as data to be migrated. At 448, a business rules statement associated with the migration of the specific type of data is determined. And at 449, a corresponding mapping rules statement based on the business rules statement, wherein the mapping rules statement is to be applied to the specific type of data to modify the data from a first format to a second format, is determined.

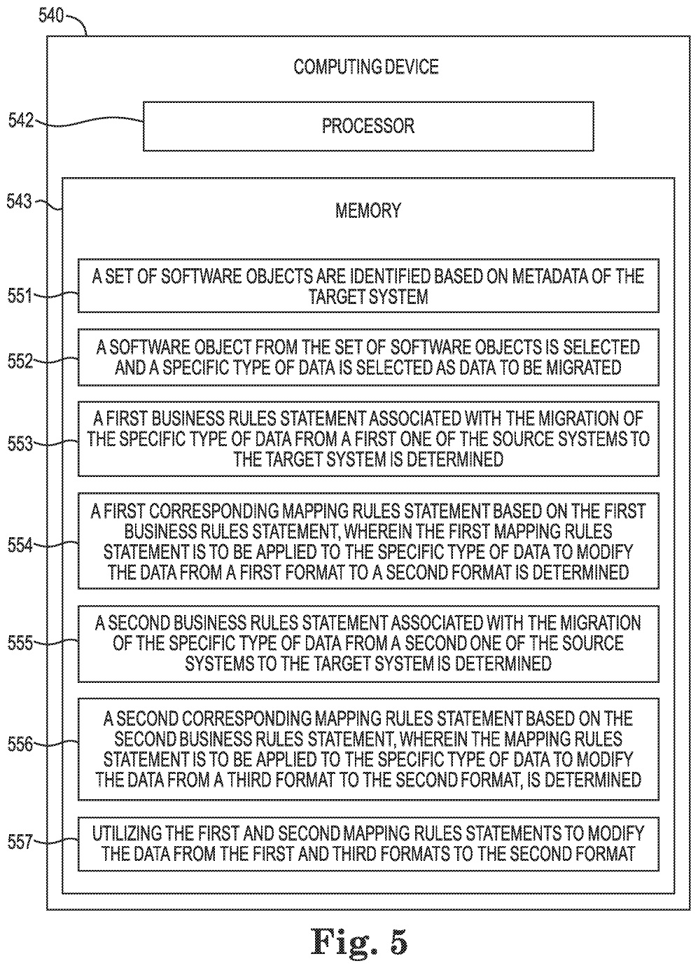

FIG. 5 illustrates another computing device being utilized for data migration management in accordance with one or more embodiments of the present disclosure. FIG. 5 provides a system for creating and tracking implementation of business and mapping rules during migration of data from multiple source systems to one target system having a computing device 540 with a processor 542 and memory 543.

Instructions are stored in memory that are executable by the processor wherein a set of software objects are identified based on metadata of the target system, at 551. At 552, a software object from the set of software objects is selected and a specific type of data is selected as data to be migrated.

A first business rules statement associated with the migration of the specific type of data from a first one of the source systems to the target system is determined, at 553. At 554, a first corresponding mapping rules statement based on the first business rules statement, wherein the first mapping rules statement is to be applied to the specific type of data to modify the data from a first format to a second format is determined.

A second business rules statement associated with the migration of the specific type of data from a second one of the source systems to the target system is determined, at 555. Further, at 556, a second corresponding mapping rules statement based on the second business rules statement, wherein the mapping rules statement is to be applied to the specific type of data to modify the data from a third format to the second format, is determined. And, at 557, instruction execute to utilize the first and second mapping rules statements to modify the data from the first and third formats to the second format.

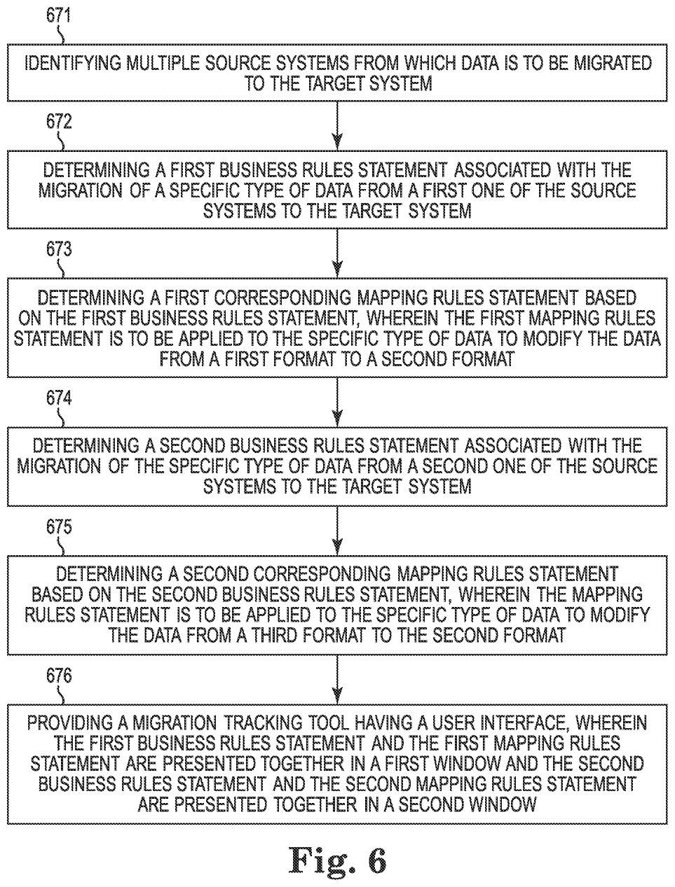

FIG. 6 illustrates a method for data migration management in accordance with one or more embodiments of the present disclosure. FIG. 6 describes a method embodiment for creating and tracking implementation of business and mapping rules during migration of data from multiple source systems to one target system.

This example method includes identifying multiple source systems from which data is to be migrated to the target system, at 671. At 672, the method determines a first business rules statement associated with the migration of a specific type of data from a first one of the source systems to the target system.

Additionally, a first corresponding mapping rules statement is determined based on the first business rules statement, wherein the first mapping rules statement is to be applied to the specific type of data to modify the data from a first format to a second format at 673. At 674, a second business rules statement associated with the migration of the specific type of data is determined from a second one of the source systems to the target system.

The embodiment continues by determining a second corresponding mapping rules statement based on the second business rules statement, wherein the mapping rules statement is to be applied to the specific type of data to modify the data from a third format to the second format, at 675. And, at 676, provides a migration tracking tool having a user interface (e.g., access portal display), wherein the first business rules statement and the first mapping rules statement are presented together in a first window and the second business rules statement and the second mapping rules statement are presented together in a second window.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

These embodiments are described in sufficient detail to enable those of ordinary skill in the art to practice one or more embodiments of this disclosure. It is to be understood that other embodiments may be utilized and that process and/or structural changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure and should not be taken in a limiting sense.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

1. A system for creating and tracking implementation of a consolidation of data during a migration from one or more source systems to one target system, comprising:
a computing device, having a processor and memory, and instructions stored in memory that are executable by the processor wherein:
a set of software objects and their attributes are identified based on metadata of the target system;
a first subset of the software objects is selected to identify information needing to be migrated from a first source system of the one or more source systems to the target system;
a second subset of the software objects is selected to identify information needing to be migrated from the first source system of the one or more source systems to the target system, and wherein the first and second subsets are merged together to form a merged subset;
a software object from the merged subset of software objects is selected and a specific type of data is selected as data to be migrated;
a business rules statement associated with the migration of the specific type of data is determined; and
a corresponding mapping rules statement based on the business rules statement, wherein the mapping rules statement is to be applied to the specific type of data to modify the data from a first format to a second format, is determined.

2. The system of claim 1, wherein the target system is an SAP system.

3. The system of claim 2, wherein the first source system is a JDE sub-system of an enterprise system.

4. The system of claim 1, wherein the first source system is a JDE sub-system of an enterprise system.

5. The system of claim 1, wherein the system includes multiple source systems including the first source and wherein data is extracted from each source and migrated to the target system.

6. The system of claim 1, wherein the business rules statement is defined by a user based on the specific type of data determined.

7. The system of claim 6, wherein the business rules statement is implemented by a technical rules statement.

8. A system for creating and tracking implementation of business and mapping rules during migration of data from multiple source systems to one target system, comprising:
a computing device, having a processor and memory, and instructions stored in memory that are executable by the processor wherein:
a set of software objects are identified based on metadata of the target system;
a software object from the set of software objects is selected and a specific type of data is selected as data to be migrated;
a first business rules statement associated with the migration of the specific type of data from a first one of the source systems to the target system is determined;
a second business rules statement associated with the migration of the specific type of data from a second one of the source systems to the target system is determined; and

9. The system of claim 8, wherein the system further includes:
a first mapping rules statement based on the first business rules statement, wherein the first mapping rules statement is to be applied to the specific type of data to modify the data from a first format to a second format is determined; and

10. The system of claim 9, wherein the system further includes:
utilizing the first mapping rules statement to modify the data from the first format to the second format.

11. The system of claim 8, wherein the system further includes:
a first mapping rules statement based on the first business rules statement, wherein the first mapping rules statement is to be applied to the specific type of data to modify the data from a first format to a second format is determined;
a second mapping rules statement based on the second business rules statement, wherein the mapping rules statement is to be applied to the specific type of data to modify the data from a third format to the second format, is determined; and

12. The system of claim 11, wherein the system further includes:
utilizing the first and second mapping rules statements to modify the data from the first and third formats to the second format.

13. The system of claim 8, wherein the first business rules statement is implemented by a technical rules statement defined by a user.

14. The system of claim 8, wherein the second format is used by the target system.

15. A method for creating and tracking implementation of business and mapping rules during migration of data from multiple source systems to one target system, comprising:
identifying multiple source systems from which data is to be migrated to the target system;
determining a first business rules statement associated with the migration of a specific type of data from a first one of the source systems to the target system;
determining a first corresponding mapping rules statement based on the first business rules statement, wherein the first mapping rules statement is to be applied to the specific type of data to modify the data from a first format to a second format;
determining a second business rules statement associated with the migration of the specific type of data from a second one of the source systems to the target system;
determining a second corresponding mapping rules statement based on the second business rules statement, wherein the mapping rules statement is to be applied to the specific type of data to modify the data from a third format to the second format; and
providing a migration tracking tool having a user interface, wherein the first business rules statement and the first mapping rules statement are presented together in a first window and the second business rules statement and the second mapping rules statement are presented together in a second window.

16. A method for creating and tracking implementation of migration rules during migration of data from one or more source systems to one target system, comprising:
creating software coding to manage the translations;
generating coding scripts to implement the software coding;
identifying a task performed by the target system;
determining data needed for performing the task;
reviewing available data in one or more source systems to find a correct data field to use;
defining a script to extract the data; and
defining a script to migrate the data to the target system

17. The method of claim 16, wherein the method further includes:
recording the business rule; and
presenting the business rule to a user via a user interface.

18. The method of claim 17, wherein the method further includes:
recording a technical rule used to implement the business rule; and
presenting the business rule to a user via a user interface.

19. The method of claim 16, wherein the method further includes:
recording a technical rule used to implement the business rule; and
presenting the business rule to a user via a user interface.

20. The method of claim 17, wherein the method further includes defining a script to translate the data from a first format to a second format.
